(19) United States
(12) Patent Application Publication
(10) Pub. No.: US 2025/0020525 A1
(43) Pub. Date: Jan. 16, 2025

(54) HAYMAKING MACHINE

(71) Applicant: MASCHINENFABRIK BERNARD KRONE GMBH & CO. KG, SPELLE (DE)

(72) Inventors: BERND JOHANNING, MELLE (DE); ANDREJ BAISER, OSNABRUECK (DE)

(73) Assignee: MASCHINENFABRIK BERNARD KRONE GMBH & CO. KG, SPELLE (DE)

(21) Appl. No.: 18/766,681

(22) Filed: Jul. 9, 2024

(30) Foreign Application Priority Data
Jul. 14, 2023 (DE) 10 2023 118 727.9

(51) Int. Cl. G01L 5/00; A01D 78/10; A01D 80/02

(52) U.S. Cl. CPC G01L 5/0057; A01D 78/1078; A01D 80/02

(57) ABSTRACT

A haymaking machine for tedding or raking agricultural stalk or leaf material includes a tedding or raking rotor arranged on a machine beam. The tedding or raking rotor is rotated about a vertical axis when working/operating. The tedding or raking rotor includes two tine arms aligned approximately radially which are uniformly distributed in a circumferential direction about the vertical axis, a first spring tine having a first length arranged on the two tine arms, a second spring tine having a second length arranged on the at least two tine arms, a first measuring device which interacts with the first spring tine, and a second measuring device which interacts with the second spring tine. The second length is smaller than the first length. The first measuring device measures a force acting on the first spring tine. The second measuring device measures a force acting on the second spring tine.

### CROSS REFERENCE TO PRIOR APPLICATIONS

Priority is claimed to German Patent Application No. DE 10 2023 118 727.9, filed Jul. 14, 2023. The entire disclosure of said application is incorporated by reference herein.

### FIELD

The present invention relates to a haymaking machine for tedding or windrowing agricultural stalk or leaf material.

### BACKGROUND

Such haymaking machines are known from the state of the art in various embodiments and are used to spread and turn agricultural stalks and leaves lying on a field or meadow area to support the drying process or to combine them into windrows so that harvesting machines can then pick up and further process the crop.

For both tedding and swathing, it is necessary that tine arms attached to tedding or swathing rotors, which are equipped with one or more spring tines, engage with the crop during the rotational movement of the tedding or swathing rotors and process it. The working height of the spring tines is ideally selected so that their tips lift the crop off the grass stubble. To avoid unwanted forage contamination, however, the tine tips should not penetrate the soil.

A rotary rake is described in EP 2 850 934 A2 where the rotor height of the raking tines of the raking rotors is set as a function of the harvested mass combined in a swath, the moisture content of the crop, and the vibration intensity of the raking tines. All criteria for determining the rotor height are based on the conveying conditions during the lateral merging of the crop on the field and meadow surface. The actual distance between the tine tips of the raking tines and the ground is not taken into account, which means that a high risk exists of unwanted forage contamination or crop losses due to the crop remaining on the ground.

### SUMMARY

An aspect of the present invention is to improve a haymaking machine so that the monitoring effort for the operator during the harvesting process is reduced, forage contamination and crop losses are avoided, and the work result is optimized.

In an embodiment, the present invention provides a haymaking machine for tedding or raking agricultural stalk or leaf material. The haymaking machine includes a machine beam, and at least one tedding or raking rotor which is arranged on the machine beam. The at least one tedding or raking rotor, in a working and operating position, is driven in a rotation about an approximately vertical axis. The at least one tedding or raking rotor comprises at least two tine arms which are aligned approximately radially and which are uniformly distributed in a circumferential direction about the vertical axis, at least one first spring tine having a first length which is arranged on the at least two tine arms, at least one second spring tine having a second length which is arranged on the at least two tine arms, at least one first measuring device which interacts with the at least one first spring tine, and at least one second measuring device which interacts with the at least one second spring tine. The second length of the at least one second spring tine is smaller than the first length of the at least one first spring tine. The at least one first measuring device is configured to measure a force acting on the at least one first spring tine and to emit measuring signals thereof. The at least one second measuring device is configured to measure a force acting on the at least one second spring tine and to emit measuring signals thereof.

### BRIEF DESCRIPTION OF THE DRAWINGS

The present invention is described in greater detail below on the basis of embodiments and of the drawings in which:

FIG. 1 is a schematic view from above showing a working train consisting of a tractor and a haymaking machine according to the present invention;

FIG. 2 is a view of a first embodiment of a tine arm fitted with spring tines according to FIG. 1;

FIG. 3 is a view of a second embodiment of a tine arm fitted with spring tines according to FIG. 1;

FIG. 4 is a view of a third embodiment of a tine arm fitted with spring tines; and

FIG. 5 shows a representation of the signal curves of the measurement signals over time.

### DETAILED DESCRIPTION

The present invention provides a haymaking machine for tedding or raking agricultural stalk or leaf material having at least one tedding or raking rotor which is arranged on a machine beam, is driven in a working and operating position so as to rotate about an approximately vertical axis, and is provided with at least two or more approximately radially aligned tine arms which are uniformly distributed in a circumferential direction about the vertical axis, at least one first spring tine being arranged on the tine arms and having a first length, and at least one second spring tine being arranged on the tedding or raking rotor and having a second length which is smaller than the first length, the tine or raking rotor comprising at least one first measuring device, which interacts with the first spring tine, and a second measuring device, which interacts with the second spring tine, the measuring devices each being provided for measuring a force acting on the respective spring tine. The present invention thus opens up the possibility of clearly detecting whether or not the spring tine of a tine arm of a tedder or raking rotor of the haymaking machine comes into contact with the soil of the field or meadow surface during work. By measuring the force acting on the respective spring tines, a clear difference between the normal conveying of the stalk and leaf material during tedding or raking and the contact of the tine tip of one of the spring tines with the ground can be determined. This difference can be determined as the difference between the measuring signals of the first measuring means on the first spring tine and the second measuring means on the second spring tine. The determined measurement signals are thus forwarded to a control device of the haymaking machine connected to the first measuring device and the second measuring device. On the basis of an evaluation of the measurement signals carried out by the control device of the haymaking machine, control parameters are generated which are fed to an adjustment device for adjusting the distance between the tine tips of the spring tines of the tedding or raking rotor. To provide reliable measurement results, one tine arm of a tedding or raking rotor can, for example, be provided in each case, to which a first spring tine with a first measuring device and a second spring tine with a second measuring device are attached. It is also conceivable, however, to equip several tine arms of a tedding or raking rotor with a first spring tine with a first measuring device and a second spring tine with a second measuring device.

In a further development of the present invention, the measurement signals can also be used to generate control parameters which are used to set an adjustment angle of the tedding or raking rotor(s) in relation to the ground of the field or meadow area. In particular when tedding agricultural stalks or leaves, the tine distance of the spring tines to the ground is set by adjusting the setting angle of the tedding rotors.

The present invention provides that the force acting on the respective spring tine is detected by measuring a torque and/or a change in position and/or a deformation of the respective spring tine. The measurement of the force acting on the respective spring tine by determining a torque or a change in position is based on the fact that the force acting on the tip of the spring tine causes a torque around the tine arm or a change in position around the tine arm under the effect of the force. These are mechanical reactions that can be measured simply. The force acting on the respective spring tine can, for example, be determined by detecting a deformation of the spring tine. The present invention thus utilizes a simple and cost-effective measuring method.

To carry out the measurement of a torque or a change in position, it is intended that the first and second measuring devices are connected at one end to the tine arm and at the other end to the respective spring tine. The first and second measuring devices can, for example, be attached to the respective spring tine, as this solution is easy to implement in terms of design.

The present invention provides that the spring tines are arranged in pairs. For this purpose, the pairs of tines are provided with a resiliently flexible attachment section from which the spring tines extend towards the ground. Each of the pairs of tines can be spatially assigned to an outer end of the tine arm. In principle, however, the spring tines of pairs of tines arranged further inwards or spring tines of different pairs of tines can also be used for the measurement. This design can be used advantageously on raking rotors as a number of raking tines must be arranged at the end of a tine arm for the raking process, which perform the raking work.

It is advantageous to arrange the first measuring device on the first spring tine of the pair of tines and the second measuring device on the second spring tine of the pair of tines. It is also, however, conceivable to attach the first measuring device to a first pair of tines and the second measuring device to a second pair of tines. In this solution, the spring tines of the second pair of tines are to be formed with a second length that is smaller than a first length of the first pair of tines. This embodiment is also advantageous for raking work.

In a structurally simple and cost-effective embodiment, the first and second measuring devices are designed as strain measurement sensors. Strain measurement sensors have the advantage that they are easy to attach to spring tines and that they supply an electrical voltage as an output signal. This provides a measurement signal that can easily be evaluated and further processed.

To evaluate the measurement signals, a control device is provided which is assigned to the haymaking machine. Via an ISOBUS connection, the control device can, of course, also be attached to a tractor or similar machine driving the haymaking machine. For further processing of the measuring signals, the control device is connected to the first and second measuring devices and is set up to determine a difference between the measuring signals of the first and second measuring devices. The difference between the measurement signals thus provides a clear control parameter for controlling the working height of the tine tips of the spring tines of tedders or raking rotors.

To minimize the monitoring effort for the operator, the present invention provides that the haymaking machine has an adjustment device for setting a distance between a tine tip of a spring tine and the ground. This adjustment device can be assigned directly to the tedding or raking rotor or can act on the tedding or raking rotor via kinematic lever deflections from the machine beam of the haymaking machine. To carry out an automatic adjustment process, the control device forwards control parameters to the adjustment device so that the control device is thus set up to adjust the distance of the tedding or raking rotor depending on the difference in the measurement signals. According to a further development, the adjustment device can also be designed to set an adjustment angle of the tedding or raking rotor in relation to the ground. Control parameters of the control device, which are determined using the difference in the measurement signals, are also used therefor.

The present invention also provides a work train comprising a tractor or similar towing and driving machine, wherein a haymaking machine according to the present invention is mounted or attached to the tractor. In this context, the term tractor is to be understood to mean not only manned towing and driving machines, but also autonomously operating towing and driving machines.

The present invention also provides a method in which the control of a haymaking machine is based on a difference between the measurement signals of a first measuring means arranged on a first spring tine of a first length and a second measuring means arranged on a second spring tine of a second length for detecting a force acting on a spring tine in each case. Control parameters, which are based on a difference in the measurement signals, are used to set a distance between a tine tip of a spring tine and the ground and/or a setting angle of the tedding or raking rotor in relation to the ground as a function of the detected difference. The proposed method is therefore advantageously suitable for the implementation of autonomous field cultivation strategies.

An advantageous embodiment of the present invention is described below with reference to the drawings.

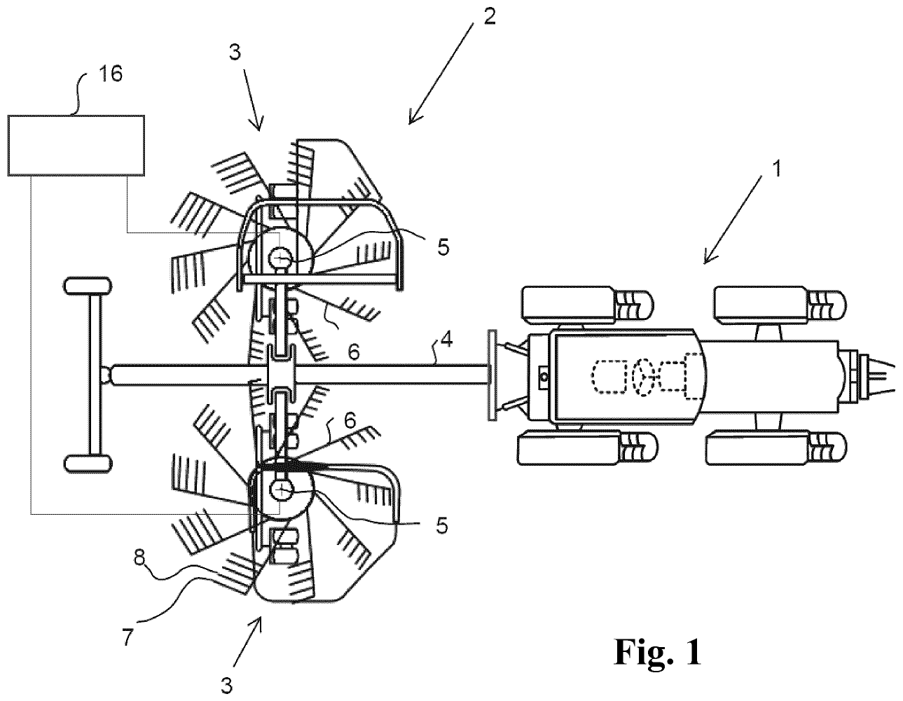

FIG. 1 shows a work train consisting of a tractor 1 and a haymaking machine 2 attached to the tractor 1 in the form of a rotary rake. Haymaking machines of this type are designed to combine widely distributed forage or leaves into swaths so that subsequent harvesting machines can pick up the forage or leaves lying in swaths and process them further. In order to combine the forage or leaves, the haymaking machine 2 is provided with tedders or raking rotors 3, which are articulated to a machine beam 4 and are driven in rotation about an approximately vertical axis 5. It can also be seen that the tedding or raking rotors 3 are evenly distributed in the direction of rotation and equipped with radially outwardly aligned tine arms 6. The direction of rotation is selected so that, as viewed in the direction of travel, the tedding or raking rotors 3 converge towards the center at their front, with the swath being formed in the area between the tedding or raking rotors 3.

To adjust the distance between a tine tip of the spring tines 7, 8 and the ground, the haymaking machine 2 comprises an adjusting device 16. In an advantageous embodiment, the adjusting device 16 can be directly associated with the tedding or raking rotor 3. An embodiment is also conceivable in which an adjusting device 16 is provided which acts on the tedding or raking rotors 3 from the machine beam 2 of the haymaking machine 2.

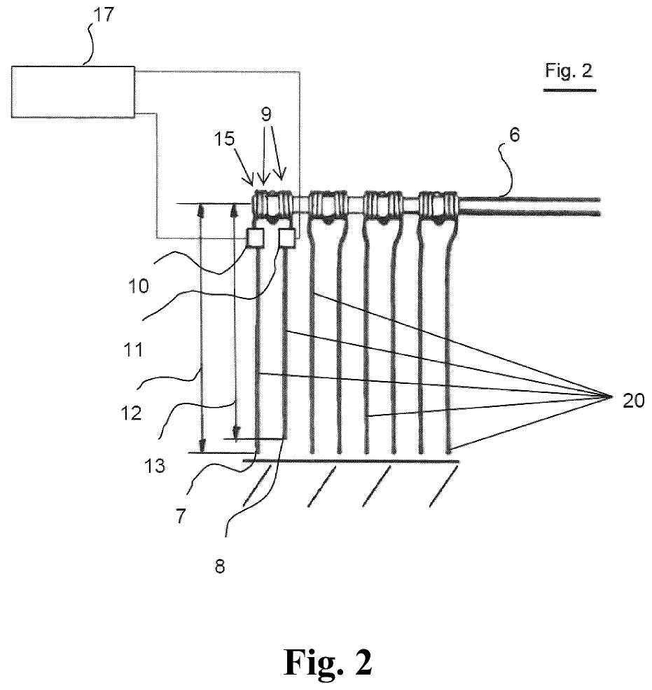

FIG. 2 shows a first embodiment of a tine arm 6 of the tedding or raking rotor 3 of the haymaking machine 2 on which a plurality of spring tines 20 are arranged. Measuring devices 10 are attached to two of the spring tines 20. These spring tines 20 are referred to below as the first spring tine 7 and the second spring tine 8. The first and second spring tines 7, 8 are here arranged at an outer end 15 of the tine arm 6. They can, however, also be arranged further inwards on the tine arm 6. The first spring tine 7 and the second spring tine 8 can also be spaced apart by one or more further spring tines 20. The spring tines 20, 7, 8 are attached to the tine arm 6 via a resiliently flexible attachment section 9 that is spatially allocated to the tine arm 6 and connected thereto in a torsionally rigid manner.

A first measuring device 10 is attached to the first spring tine 7 and a second measuring device 11 is attached to the second spring tine 8. For this purpose, the measuring devices 10, 11 can, for example, be mounted in an upper region of an approximately rod-shaped section of the first and second spring tine 7, 8 facing the fastening section 9, which extends from the attachment section 9 to the ground. It can also be seen from FIG. 2 that the first spring tine 7 has a rod-shaped section with a first length 12 and the second spring tine 8 has a rod-shaped section with a second length 13. Due to the difference between the first length 12 and the second length 13, during the operation of the haymaking machine according to the present invention, it is possible to detect by measurement a clear difference between the measuring signals on the first spring tine 7 and on the second spring tine 8. Advantageously, if the first spring tine 7 makes contact with the ground, the difference between the first length 12 of the first spring tine 7 and the second length 13 of the second spring tine 8 reliably prevents the second spring tine 8, which in this case has a shorter length 13 than the first spring tine 7, from also making contact with the ground. Different forces acting on the first and second spring tines 7, 8 are thus reliably measured by the first measuring device 10 and the second measuring device 11.

The analogous effect can in principle also be achieved with a tine arm 6 in which only one spring tine 20, which serves as the first spring tine 7 and has a measuring device 10, and is longer than all the other spring tines 20. One of the other spring tines 20 in this case serves as the second spring tine 8 and therefore also has a measuring device 10.

These forces acting on the spring tines 7, 8 are transmitted to a control device 17 by the first measuring device 10 and the second measuring device 11. By evaluating the measurement signals via the control device 17, control parameters are generated which are fed to the adjustment device 16 in order to carry out an automatic control of a distance of a tine tip of a spring tine 7, 8 from the ground and/or an adjustment angle in relation to the ground.

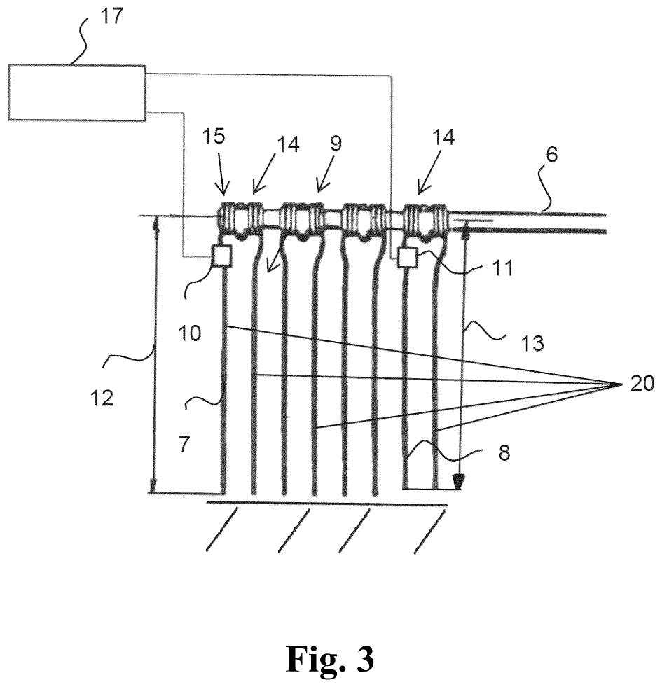

FIG. 3 shows a second embodiment of a tine arm 6 on which pairs of tines 14, each having two spring tines 20, are attached to the tine arm 6 at regular intervals starting from the outer end 15 of the tine arm 6. The pair of tines 14 at the outer end 15 of the tine arm 6 has a first spring tine 7, and another pair of tines 14 has a second spring tine 8, on each of which the measuring devices 10, 11 are arranged. The two spring tines 20 of the pair of tines 14 at the outer end 15 of the tine arm 6 each have a rod-shaped section with a first length 12, while the spring tines 20 of the other pair of tines 14 each have a rod-shaped section with a second length 13. The second length 13 is here also smaller than the first length 12. In this embodiment, the detection of different forces acting on the spring tines 7, 8 can be used in the same way as in the embodiment example shown in FIG. 2.

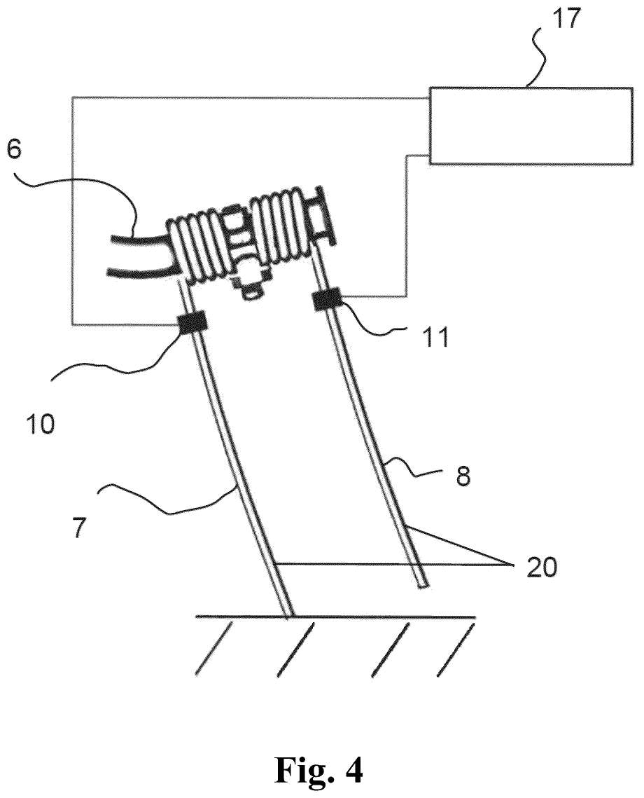

FIG. 4 shows an embodiment of a further tine arm 6 on which a first spring tine 7 with a first measuring device 10 and a second spring tine 8 with a second measuring device 11 are arranged. This embodiment here illustrated can, for example, be used for tedding agricultural stalks or leaves. Different measurement signals from the first measuring device 10 and the second measuring device 11 are here also forwarded to a control device 17 so that they can be fed to the adjusting device 16 of the haymaking machine 2 after appropriate evaluation and conversion into control parameters. This makes it possible to automatically control a distance of a tine tip of a spring tine 7, 8 from the ground and/or an adjustment angle in relation to the ground.

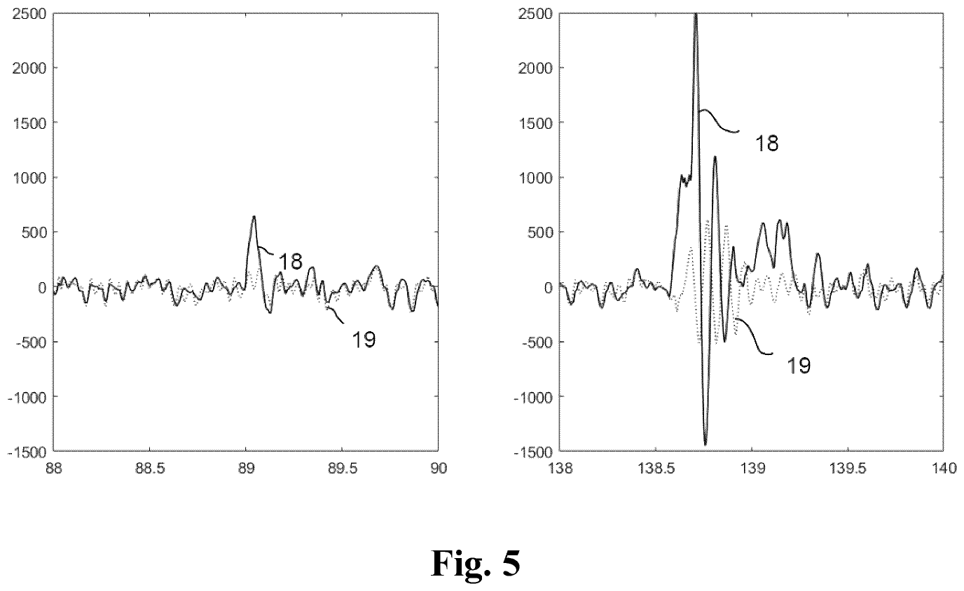

FIG. 5 shows two diagrams with signal curves 18, 19 of the measurement signals measured by the first measuring device 10 on the first spring tine 7 and the second measuring device 11 on the second spring tine 8. A first signal curve 18 is shown as a solid line and is recorded by the first measuring device 10. A second signal curve 19 is shown as a dotted line and is recorded by the second measuring device 11. The vertical axes of the diagrams are divided into digits with a constant scale, which correspond to an electrical voltage. The horizontal axes of the diagrams represent a time axis.

The left-hand diagram in FIG. 5 shows the signal curves 18, 19, which are generated during normal processing of the agricultural stalk or leaf crop without one of the tine tips of the spring tines 7, 8 touching the ground. The signal curves 18,19 are comparatively close to each other. Structural differences in the signal curves 18,19 are due to accumulations of the stalk or leaf material lying distributed on the field or meadow area and intended for processing.

In the right-hand diagram in FIG. 5, on the other hand, the signal curves 18, 19 are illustrated which occur when the longer, here first spring tine 7, touches the soil of the field or meadow surface during cultivation. Compared to the level of the signal curves from the left-hand diagram (normal conveying), the level of the measurement signal of signal curve 18 in the right-hand diagram is significantly higher. A considerable difference can therefore be seen between the measurement signal of the first measuring device 10 of the first spring tine 7 and the measurement signal of the second measuring device 11 of the second spring tine 8. This considerable difference between the measurement signals allows for a reliable, automatic control of a distance of a tine tip of a spring tine 7, 8 from the ground and/or an adjustment angle in relation to the ground after a corresponding evaluation by the control device 17.

The present invention is not limited to embodiments described herein; reference should be had to the appended claims.

### LIST OF REFERENCE NUMERALS

1 Tractor
2 Haymaking machine
3 Tedders or raking rotors
4 Machine beam
5 Vertical axis
6 Tine arm
7 First spring tine
8 Second spring tine
9 Attachment section
10 First measuring device
11 Second measuring device
12 First length
13 Second length
14 Pair of tines
15 Outer end
16 Adjusting device
17 Control device
18 First signal curve
19 Second signal curve
20 Spring tines

1-10. (canceled)

11: A haymaking machine for tedding or raking agricultural stalk or leaf material, the haymaking machine comprising:
a machine beam; and
at least one tedding or raking rotor which is arranged on the machine beam, the at least one tedding or raking rotor, in a working and operating position, being driven in a rotation about an approximately vertical axis, the at least one tedding or raking rotor comprising,
at least two tine arms which are aligned approximately radially and which are uniformly distributed in a circumferential direction about the vertical axis,
at least one first spring tine having a first length which is arranged on the at least two tine arms,
at least one second spring tine having a second length which is arranged on the at least two tine arms, the second length being smaller than the first length of the at least one first spring tine,
at least one first measuring device which interacts with the at least one first spring tine, the at least one first measuring device being configured to measure a force acting on the at least one first spring tine and to emit measuring signals thereof, and
at least one second measuring device which interacts with the at least one second spring tine, the at least one second measuring device being configured to measure a force acting on the at least one second spring tine and to emit measuring signals thereof.

12: The haymaking machine as recited in claim 11, wherein,
the force acting on the at least one first spring tine is detected by measuring at least one of a torque, a change in position, and a deformation of the at least one first spring tine, and/or
the force acting on the at least one second spring tine is detected by measuring at least one of a torque, a change in position, and a deformation of the at least one second spring tine.

13: The haymaking machine as recited in claim 11, wherein,
the at least one first measuring device is arranged on the at least one first spring tine, and the at least one second measuring device is arranged on the at least one second spring tine, or
the at least one first measuring device is connected at one end to the tine arm and at the other end to the at least one first spring tine, and the at least one second measuring device is connected at one end to the tine arm and at the other end to the at least one second spring tine.

14: The haymaking machine as recited in claim 11, wherein,
the at least one first spring tine and the at least one second spring tine are arranged as a pair of tines,
each of the pair of tines comprise an attachment section which is configured to be resiliently flexible, and
each of the at least one first spring tine and the at least one second spring tine are arranged to extend towards the ground from the attachment section.

15: The haymaking machine as recited in claim 14, wherein,
the at least one first measuring device is arranged on the at least one first spring tine of the pair of tines and the at least one second measuring device is arranged on the at least one second spring tine of the pair of tines, or
the at least one first measuring device is arranged on a first pair of tines and the at least one second measuring device is arranged on a second pair of tines.

16: The haymaking machine as recited in claim 11, wherein,
the at least one first measuring device is a strain gauge sensor, and
the at least one second measuring device is a strain gauge sensor.

17: The haymaking machine as recited in claim 11, further comprising:
a control device which is connected to the at least one first measuring device and to the at least one second measuring device, the control device being configured to detect a difference between the measuring signals of the at least one first measuring device and the measuring signals of the at least one second measuring device.

18: The haymaking machine as recited in claim 17, further comprising:
further spring tines which are arranged on the at least two tine arms; and
an adjusting device which is configured to adjust at least one of,
a distance of a tine tip of the at least one first spring tine, of the at least one second spring tine, and of the further spring tines from the ground, and
an adjusting angle of the at least one tedding or raking rotor in relation to the ground,
wherein,
the control device is further configured to adjust at least one of the distance and the adjusting angle as a function of the difference between the measuring signals of the at least one first measuring device and the measuring signals of the at least one second measuring device.

19: A work train comprising:
a tractor; and
the haymaking machine as recited in claim 11,
wherein,
the haymaking machine is attached to or mounted to the tractor.

20: A method for controlling a tedding or raking rotor of a haymaking machine, the method comprising:
detecting a difference between measurement signals of a first measuring device which is arranged on a first spring tine having a first length to detect a force acting on the first spring tine, and measurement signals of a second measuring device which is arranged on a second spring tine having a second length to detect a force acting on the second spring tine; and
setting at least one of,
a distance of a tine tip of the first spring tine and of the second spring tine from the ground as a function of the detected difference, and
a setting angle of the tedding or raking rotor in relation to the ground as a function of the detected difference.

21: The method for controlling the at least one tedding or raking rotor of the haymaking machine as recited in claim 11, the method comprising:
detecting a difference between the measurement signals of the at least one first measuring device which is arranged on the at least one first spring tine to detect the force acting on the at least one first spring tine, and the measurement signals of the at least one second measuring device which is arranged on the at least one second spring tine to detect the force acting on the at least one second spring tine; and
setting at least one of,
a distance of a tine tip of the at least one first spring tine and of the at least one second spring tine from the ground as a function of the detected difference, and
a setting angle of the at least one tedding or raking rotor in relation to the ground as a function of the detected difference.
